(19) United States
(12) Patent Application Publication
(10) Pub. No.: US 2024/0152259 A1
(43) Pub. Date: May 9, 2024

(54) SYSTEM FOR FORMAT AGNOSTIC MEDIA PLAYBACK

(71) Applicant: Spotify AB, Stockholm (SE)

(72) Inventors: Erik Johan Curcio Lindström, Stockholm (SE); Lars Erik Carlsson, Göteborg (SE)

(73) Assignee: Spotify AB, Stockholm (SE)

(21) Appl. No.: 18/468,186

(22) Filed: Sep. 15, 2023

Related U.S. Application Data
(60) Provisional application No. 63/375,785, filed on Sep. 15, 2022.

(51) Int. Cl. G06F 3/0484

(52) U.S. Cl. CPC G06F 3/0484

(57) ABSTRACT

Systems and methods for providing format agnostic media playback may include a media delivery system that can determine media content responses for media playback devices to use to determine how to operate when playing media content. To initiate the format agnostic media playback, a request for media content may be received from a media playback device. In response to the request a media content format of the media content may be determined, and a media content response may be determined based on the media content format. The media content response may be sent to the media playback device for the media playback device to playback media content and/or to determine media content descriptions, player features, user interface formats, actions, and/or a timeline of media content items to play.

### CROSS-REFERENCE TO RELATED APPLICATION(S)

This application claims priority to U.S. Application No. 63/375,785, filed on Sep. 15, 2022, and titled SYSTEM FOR FORMAT AGNOSTIC MEDIA PLAYBACK, the disclosure of which is hereby incorporated by reference in its entirety.

### BACKGROUND

Media services that provide media content items for user consumption often enable user interface features based on media content item formats. For example, a user may be enabled to select an icon or other similar control element of a user interface displayed on a device playing back the media content item based on the format of the media content item. A media service may need to provide a description file or container for each media content item to initiate playback on the device. The device may store the provided description file or container for each media content item to use when playing the media content item.

When a new media format is to be implemented by the media service, the media service client for user devices may need to be updated for supporting the new media format. The new media format may require the definition of the description file or container that defines the various playback actions, such as playback controls the media client displays. The updates may be specific to types of user devices, may take time to be developed, and sometimes may not update. Consequently, some users may not be able to consume newer media formats or content because outdated clients may not have access to the associated description file or container.

### SUMMARY

In general terms, this disclosure is directed to systems and methods for format agnostic media playback. In one possible configuration and by non-limiting example, a media playback device may communicate with a media delivery system to play media content items and display player features in a user interface while playing media content items. The player features and user interface may change based on the format of the media content item. The media playback system may send a media content request to the media delivery system, and the media delivery system may determine and send a media content response to the media playback device in response to the media content request. The media playback device may use the media content response to determine media content descriptions, player features, user interface formats, actions, and/or a timeline of media content items to play. Various aspects are described in this disclosure, which include, but are not limited to, the following aspects.

One aspect is a method for format agnostic media playback. An example method includes receiving a request for a media content item from a media playback device; determining a media content format of the media content item; determining a media content response based on the media content format; and sending the media content response to the media playback device.

In some aspects, the request may be a media playback request data structure. The media content response may be a media content response data structure. The media content response may include any of (i) a media content description, (ii) player features, (iii) a user interface format, (iv) actions, or (v) any combination of (i)-(iv). The method may further include receiving a playback action from the media playback device; determining an action in response to the playback action; and sending the action to the media playback device. The playback action may be any one of (i) skip to a next media content item, (ii) skip to a previous media content item, (iii) play, (iv) finished playing, (v) failed to play, (vi) shuffle on, (vii) shuffle off, (viii) period passed since starting play, (ix) user subscription change, or (x) any combination of (i)-(ix); and the action may be any one of (xi) do nothing, (xii) reload, (xiii) jump to another media content item, (xiv) pause, (xv) play, (xvi) turn off shuffle, (xvii) turn on shuffle, or (xviii) any combination of (xi)-(xvii). The method may further include determining the media content format is a new media content format; and creating the media content response for the media content format. The request may include a plurality of media content items, and the method may further include determining a timeline of the plurality of media content items by arranging the plurality of media content items based on the positions of the other media content items.

Another aspect is a method for format agnostic media playback. The example method includes receiving a request to play a media content item; sending a request for the media content item to a media delivery system; receiving a media content response from the media delivery system; determining any one of (i) a media content description, (ii) player features, (iii) a user interface format, (iv) actions, or (v) any combination of (i)-(iv) based on the media content response; displaying a user interface based on the media content response; and playing the media content item.

In some aspects, the request for the media content item may include any of (vi) a user identifier (ID), (vii) a media content ID, (viii) a playback action, or (ix) any combination of (vi)-(viii). The request to play the media content item is a selection of any of (vi) a song, (vii) a playlist, (viii) an album, (ix) a video, (x) a podcast, (xi) an audiobook, or (xii) any combination of (vi)-(xii). The method may further include receiving a playback action; sending the playback action to the media delivery system; receiving an action from the media delivery system; and performing the action. The playback action may be any one of (i) skip to a next media content item, (ii) skip to a previous media content item, (iii) play, (iv) finished playing, (v) failed to play, (vi) shuffle on, (vii) shuffle off, (viii) period passed since starting play, (ix) user subscription change, or (x) any combination of (i)-(ix); and the action may be any one of (xi) do nothing, (xii) reload, (xiii) jump to another media content item, (xiv) pause, (xv) play, (xvi) turn off shuffle, (xvii) turn on shuffle, or (xviii) any combination of (xi)-(xvii). The media content response may include any of (vi) the media content description, (vii) player features, (viii) the user interface format, (ix) actions, or (x) any combination of (vi)-(ix). The media content response may include a timeline of a plurality of media content items, and the method may further include playing the plurality of media content items based on the timeline.

Another aspect is a system for providing format agnostic media playback. The example system includes a media playback device configured to play media content items; and a media delivery system configured to: receive a request for a media content item from the media playback device; determine a media content format of the media content item; determine a media content response based on the media content format; and send the media content response to the media playback device.

In some aspects, the request may be a media playback request data structure. The media content response may be a media content response data structure. The media delivery system may be further configured to: receive a playback action from the media playback device; determine an action in response to the playback action; and send the action to the media playback device. The media delivery system may be further configured to determine a timeline of the plurality of media content items by arranging the media content items based on the positions of the other media content items.

### BRIEF DESCRIPTION OF THE DRAWINGS

FIG. 1 illustrates an example operating environment for a media playback device and a media delivery system.

FIG. 2 illustrates example data structures for providing format agnostic media playback.

FIG. 3 illustrates an example media playback device.

FIG. 4 illustrates an example media delivery system.

FIG. 5 illustrates a signaling process for providing format agnostic media playback.

FIG. 6 illustrates a media playback timeline.

FIG. 7 illustrates a signaling process for providing actions to a media playback device.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

A media playback device may include a music playback application associated with a media service to play media content items and display player features in a user interface while playing media content items. The player features and user interface may change based on the format of the media content item. For example, the media playback device may include a play and pause button and track skip buttons in the user interface while the media playback device plays a song. The media playback device may include play and pause button and fifteen second skip buttons in the user interface while the media playback device plays a podcast.

The media playback device may not store the player features and user interface format for each media content format. Therefore, the media playback device may communicate with a media delivery system associated with the media service to receive or otherwise determine the media content item to play, player features, and the user interface format for the media content item the media playback device will play to perform format agnostic media playback. The media delivery system may send a description file or media content response that includes the media content item to play, player features, and the user interface format. For example, the media playback device may send a media content Identifier (ID) that identifies one or more media content items to the media delivery system, and the media delivery system may send a response (e.g., a media content response) that includes the one or more media content items (e.g., when the media playback device does not have the media content items stored), player features for the media content item, a user interface format, and/or actions for the media playback device to take. Thus, the media playback device may use the response to display the correct selectable inputs and format the user interface for display when the media playback device plays the media content item. The media playback device may also use the response to operate as intended when the user selects the inputs.

The media playback device may also send a user ID to the media delivery system. The media delivery system's response may be based on the user ID, because the user ID may indicate the subscription level of the user, user settings, and the like that may change the player features, the user interface format, and the actions to take.

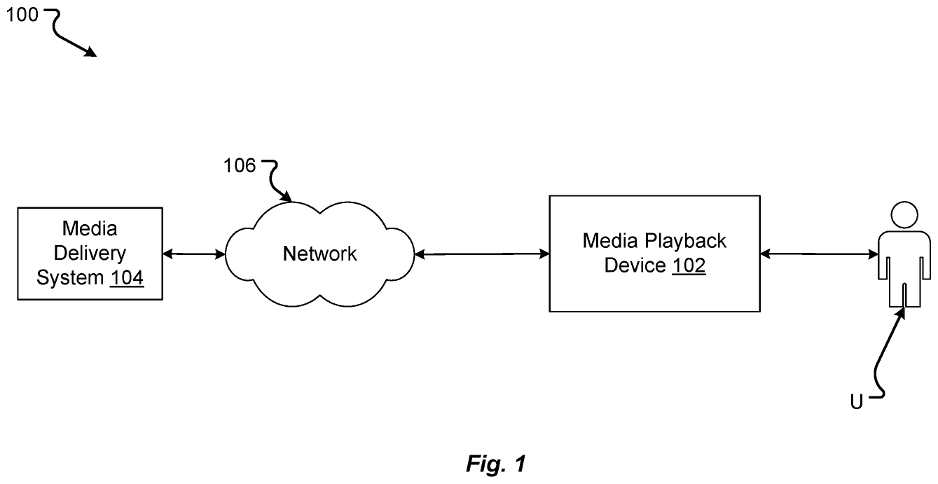

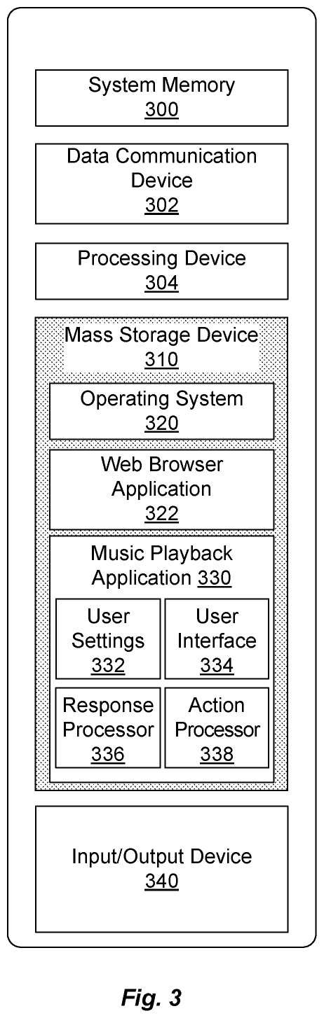

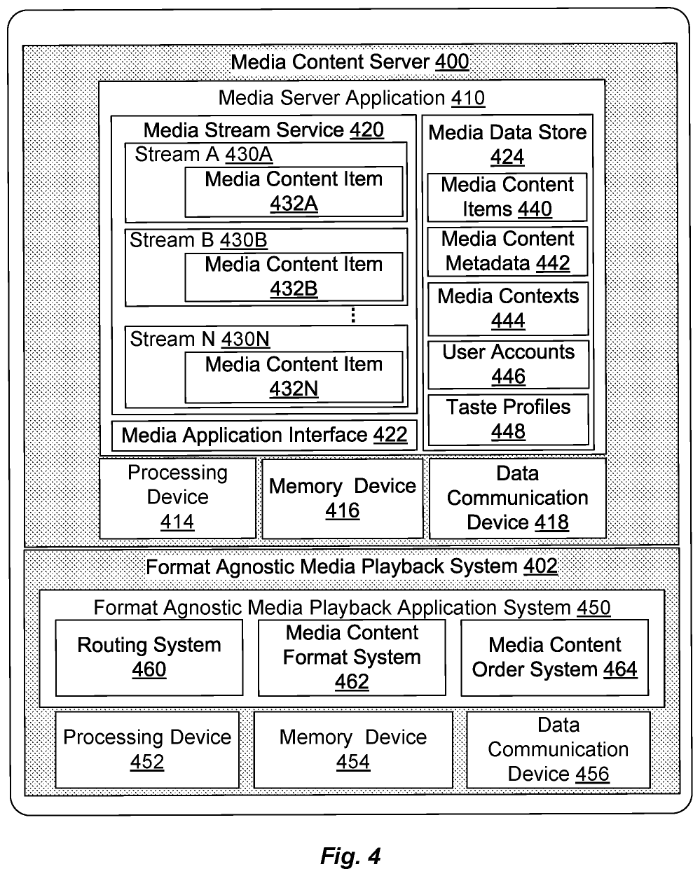

FIG. 1 illustrates an example operating environment 100 for a media playback device 102 and a media delivery system 104. An example of the media playback device 102 is illustrated and described in further detail herein, such as with reference to FIG. 3, and an example of the media delivery system 104 is illustrated and described in further detail herein, such as with reference to FIG. 4. The media playback device 102 and the media delivery system 104 may communicate via a network 106. The media playback device 102 may be associated with a user U, and the user U may operate the media playback device 102.

The user U may operate the media playback device 102 to cause the media playback device 102 to playback media content items. The user U may select media content to be played using the media playback device 102, and the media playback device 102 may communicate with the media delivery system 104 in response to the user's U selection. The media playback device 102 may send a request to the media delivery system 104 to receive media content associated with the user's U selection to perform format agnostic media playback. The media delivery system 104 may send the requested media content, the media content format, actions, and the like to the media playback device 102. Therefore, the media playback device 102 may cause playback of the media content, display controls, and perform actions based on the user's U input using the media content, the media content format, the actions, and the like.

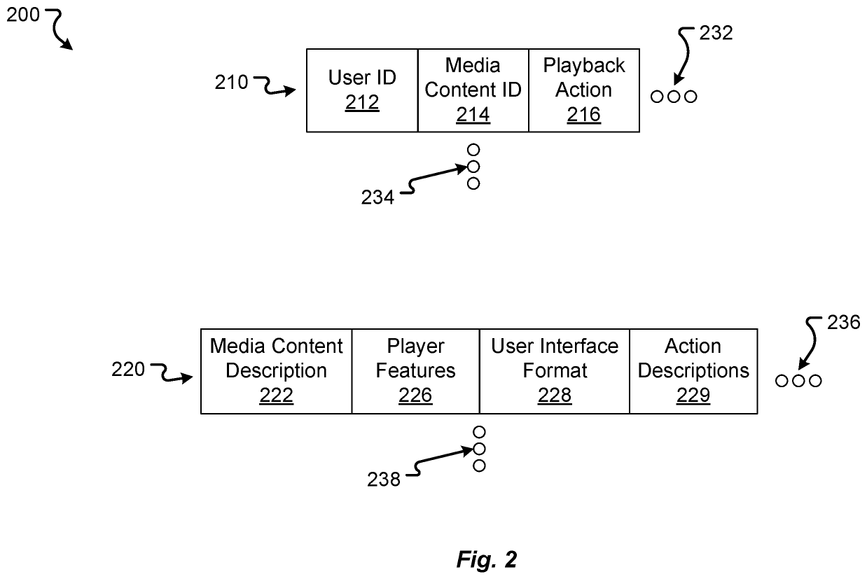

FIG. 2 illustrates example data structures 200 for providing format agnostic media playback. The data structures 200 may include a media playback request data structure 210 and a media content response data structure 220. The media playback device 102 may send the media playback request data structure 210 to the media delivery system 104 in response to the user U requesting playback of media content. The media delivery system 104 may send the media content response data structure 220 to the media playback device 102 in response to receiving a media playback request data structure 210 from the media playback device 102.

The media playback request data structure 210 may include a user ID 212, a media content ID 214, and a playback action 216. The user ID 212 may indicate the identity of a user, the user's subscription level, user settings, and other information about the user requesting to play a media content item. The media content ID 214 may indicate the selected media content, such as a song, a playlist, an album, a video, a podcast, an audiobook, and the like. The media content ID 214 may be a Uniform Resource Locator (URL) or a Uniform Resource Identifier (URI). The playback action 216 may indicate the user's U selected action, if any, such as play, skip, save, and the like. The media playback request data structure 210 may include fewer or more fields as indicated by the ellipses 232. Further, a media playback device may send multiple media request data structures 210 at once, as indicated by ellipses 234. For example, the user U may select multiple media content items to be played, and the media playback device 102 may send a media playback request data structure 210 for each selected media content item.

The media content response data structure 220 may include a media content description 222, player features 226, a user interface format 228, and action descriptions 229. The media content description 222 may include data for controlling the media playback device 102 to play a media content item, such as one or media content items associated with the media content ID 214 of a media playback request data structure 210 the media playback device 102 sends to the media delivery system 104, the order to play the one or more media content items, and the like. In some examples, the media content description 222 may also identify the format of the media content items identified by the media content description 222 (e.g., a song, a video, a podcast, an audiobook); the media content description 222 may also indicate the playback mechanisms of the media content items, such as whether the media content items can be shuffled, how to shuffle the media content items, what to do when skipping forward and backward between media content items, whether a user can rearrange the queue of media content items, and the like. The playback mechanisms may or may not be associated with the types of the media content items. For example, the media content description 222 may indicate that chapters of an audiobook cannot be shuffled so the story is not told out of order.

Moreover, the media content description 222 may also indicate the hierarchical relationship of the media content items. Many types of media content items may be nested and/or inter-linked within the single data structure. For example, an album may have multiple nested songs, an audiobook may have multiple nested chapters, and the like. The media playback device 102 may use the hierarchical relationship to determine the order to play media content items.

The player features 226 may identify the controls and selections the user U can make while a media content item the media content description 222 identifies is playing and which controls and selections the media playback device 102 should disable. The player features 226 may also define the actions the media playback device 102 should take when a user selects or otherwise uses one of the controls or selections. For example, the player features 226 may indicate that the media playback device 102 should display a play button, a pause button, a skip button, and a scrub slider and allow shuffling and reordering while playing a song the media content description 222 identifies. The user interface format 228 may indicate the format the media playback device 102 should display a user interface while playing the media comment item. The user interface format 228 may also indicate the location of features indicated by the player features 226, the icons to display for the features, and other features the media playback device 102 should display.

The action descriptions 229 may identify an action for the media playback device 102 to perform before, during, and/or after playing a media content item the media content description 222 identifies. For example, the action descriptions 229 may include monitoring the playback of the media content items, when to play advertisements, how to shuffle the media content items if the user U requests the content to be shuffled, and the like. For example, the user U may select a skip button while listening to media content, and the media playback device 102 may send the media delivery system 104 a media playback request data structure 210 with the playback action 216 indicating that the user U selected the skip button. The media delivery service may send a media content response data structure 220 with action descriptions 229 indicating the media playback device 102 should discard the queue of media content items, determine a new queue of media content items, and continue playing. Thus, the media playback device 102 does not need to store actions to take in response to input from the user U. Additionally, the media delivery system 104 may monitor the actions of the user, as indicated by the playback actions 216 for example, and determine the action descriptions 229 based on the actions of the user. For example, the user may select the skip button multiple times. After a predetermined number of skips, the media delivery system 104 may determine the action descriptions 229 should include the media playback device 102 clearing the queue and receiving a new set of media content items.

The media content response data structure 220 may include fewer or more fields as indicated by the ellipses 236. Further, a media delivery device may send multiple media content response data structures 220 at once, as indicated by ellipses 238. For example, the media delivery system 104 may send multiple media content response data structures 220 for multiple media content items (e.g., media content items selected by the user) for the media playback device 102 to play.

Media content response data structures 220 may be recursively nested in a parent-child relationship (e.g., a collection of audiobooks divided into chapters). The nested children of the parent media content may be identified (e.g., by the associated media content IDs) in the media content description 222. Alternatively, or in addition, the media content description 222 may include a list of media content items to be played organized in a timeline. The timeline may include constraints for the media playback device 102 to follow to determine when to play each media content item. The media playback device 102 may send a request, such as by using the media playback request data structure 210, to receive a media content response data structure 220 for the indicated children and/or subsequent media content items to be played periodically. For example, the media playback device 102 may send a request for a media content response data structure 220 for the next media content item at a period (e.g., thirty seconds) before the media playback device 102 will play the next media content item so the media playback device 102 will begin playing the media content item at the expected time without buffering. In another example, the media playback device 102 may immediately receive media content response data structures 220 for all children and/or subsequent media content items to be played.

FIG. 3 illustrates the example media playback device 102. The media playback device 102 may include a system memory 300, a data communication device 302, a processing device 304, a mass storage device 310, and an input/output device 340.

The data communication device 302 may operate to communicate with other devices, such as the media delivery system 104, over one or more networks, such as the network 106. Examples of the data communication device 302 include wired network interfaces and wireless network interfaces. Wireless network interfaces include infrared, BLUETOOTH® wireless technology, 802.11a/b/g/n/ac, cellular or other radio frequency interfaces wireless wide area network (WWAN) interfaces (including cellular networks), and wireless local area network (WLANs) interfaces. The data communication device 302 may send media playback request data structures 210 and receive media content response data structures 220 for example.

The processing device 304 in some embodiments comprises one or more central processing units (CPU). In other embodiments, the processing device 304 additionally or alternatively includes one or more digital signal processors, field-programmable gate arrays, or other electronic circuits.

The mass storage device 310 includes at least an operating system 320, a web browser application 322, and a media playback application 330. The mass storage device 310 (also referred to as a memory device) typically includes at least some form of computer-readable media. Computer-readable media includes any available media that can be accessed by the media playback device 102. By way of example, computer-readable media include computer-readable storage media and computer-readable communication media.

The system memory 300 may be computer-readable media. Computer-readable storage media may include volatile and nonvolatile, removable and non-removable media implemented in any device configured to store information such as computer-readable instructions, data structures, program modules, or other data. Computer-readable storage media includes, but is not limited to, random access memory, read only memory, electrically erasable programmable read only memory, flash memory and other memory technology, compact disc read only memory, blue ray discs, digital versatile discs or other optical storage, magnetic storage devices, or any other medium that can be used to store the desired information and that can be accessed by the media playback device 102. In some embodiments, computer-readable storage media is non-transitory computer-readable storage media.

The operating system 320 may provide general functionality to the media playback device 102. For example, the operating system 320 may be software that allows for basic tasks for be performed such as scheduling tasks, executing applications, and controlling peripherals.

The web browser application 322 may operate to present a user interface on the media playback device 102 for interacting with the internet. For example, the web browser application 322 may access the user interface 334 to display on the media playback device 102.

The media playback application 330 may include user settings 332, a user interface 334, a response processor 336, and an action processor 338. The media playback application 330 may receive inputs as commands to play media content, adjust settings for media content playback, and provide profile information for a user account. The media playback application 330 may receive the inputs from an input/output device 340. The media playback application 330 may also record actions related to the media content that is consumed to send to the media delivery system 104 to build a taste profile for the user account. The media playback application 330 may include user settings 332, which may be adjusted to reflect the preferences of a user associated with the user account. The user settings 332 may include the user's subscription level, a user ID, and the like. Inputs may be received at the input/output device 340 that instruct the media playback application 330 to modify settings for media playback. Updated settings may be stored in the user settings 332 database.

The input/output device 340 may include a keyboard, a touch screen, a camera, a QR reader, a barcode scanner, and the like. The user U may use the input/output device 340 to login to an account associated with the media delivery system 104, adjust user settings, select media content to play on the media playback device 102, and the like.

The media playback application 330 may change the user interface 334 based on the media content item playing, using the response processor 336 and action processor 338 for example. The media playback device 102 may receive a media content response data structure 220 from the media delivery system 104 and determine the structure of the user interface 334 based on the media content description 222, the player features 226, the user interface format 228, and/or the action descriptions 229. For example, the media playback device 102 may determine the user interface 334 to include a play button, a pause button, and a skip track button and allow shuffling and reordering for a media content item with a song media content format using the media content response data structure 220. Similarly, the media playback device 102 may determine the user interface 334 to include a play button, a pause button, a skip forward fifteen seconds button, and a skip backward fifteen seconds button and not allow shuffling or reordering for an audiobook media content format using the media content response data structure 220. For an advertisement, the media playback device 102 may determine the user interface 334 to include only a play and pause button. In an example, the action descriptions 229 may instruct the media playback device 102 to play an advertisement once the currently playing media content item finishes or when the user U skips the currently playing media content item using the input/output device 340. The media delivery system 104 may have determined the action descriptions 229 based on the user's subscription level.

The media playback application 330 may use response processor 336 to process received media content responses, such as the media content response data structure 220. The response processor 336 may determine the information included in the media content description 222, player features detailed in the player features 226, the format of the user interface 334 when a media content item is playing in the user interface format 228, and or actions to perform in the action descriptions 229.

The action processor 338 may determine actions for the media playback application 330 to execute. The action processor 338 may determine the actions in the action descriptions 229 or receive the actions from the response processor 336. The action processor 338 may then determine the operation of the media playback application 330 to execute the actions.

FIG. 4 illustrates the example media delivery system 104. The media delivery system 104 may include a media content server 400 and a format agnostic media playback system 402. The media delivery system 104 may comprise one or more computing devices and may provide media content to user devices, such as the media playback device 102, using the media content server 400 and the format agnostic media playback system 402.

In at least some embodiments, the media content server 400 and the format agnostic media playback system 402 are provided by separate computing devices. In other embodiments, the media content server 400 and the format agnostic media playback system 402 are provided by the same computing device(s). Further, in some embodiments, at least one of the media content server 400 and the format agnostic media playback system 402 is provided by multiple computing devices. For example, the media content server 400 and the format agnostic media playback system 402 may be provided by multiple redundant servers located in multiple geographic locations.

Although FIG. 4 illustrates a single media content server 400 and format agnostic media playback system 402, some embodiments include multiple media servers and/or multiple format agnostic media playback systems. In these embodiments, each of the multiple media servers and multiple format agnostic media playback systems may be identical or similar to the media content server 400 and the format agnostic media playback system 402, respectively, as described herein, and may provide similar functionality with, for example, greater capacity and redundancy and/or services from multiple geographic locations. Alternatively, in these embodiments, some of the multiple media servers and/or the multiple format agnostic media playback systems may perform specialized functions to provide specialized services. Various combinations thereof are possible as well.

The media content server 400 may transmit media content to media playback devices such as the media playback device 102. The media content server 400 may include a media server application 410, a processing device 414, a memory device 416, and a data communication device 418. The processing device 414 and the memory device 416 may be similar to the processing device 304 and the system memory 300, respectively, which have each been previously described.

The format agnostic media playback system 402 may transmit media content descriptions, player features, user interface formats, actions, and the like to media playback devices such as the media playback device 102. The format agnostic media playback system 402 may include a format agnostic media playback application system 450, a processing device 452, a memory device 454, and a data communication device 456. The processing device 452 and the memory device 454 may be similar to the processing device 304 and the system memory 300, respectively, which have each been previously described.

The data communication device 418 and the data communication device 456 may operate to communicate with other computing devices over one or more networks, such as the network 106. Examples of the data communication device 418 and the data communication device 456 include one or more wired network interfaces and wireless network interfaces. Examples of such wireless network interfaces of the data communication device 418 include WWAN interfaces (including cellular networks) and WLAN interfaces. In other examples, the data communication device 418 and the data communication device 456 use other types of wireless interfaces.

In some embodiments, the media server application 410 may be configured to stream media content, such as music, audiobooks, podcasts, or other audio, video, or other suitable forms of media content. The media server application 410 may include a media stream service 420, a media application interface 422, and a media data store 424. The media stream service 420 may operate to buffer media content, such as media content items 432A, 432B, and 432N, for streaming to one or more streams 430A, 430B, and 430N.

The media data store 424 may store media content items 440, media content metadata 442, media contexts 444 (e.g., playlists, audiobook chapters, albums, podcast episodes), user accounts 446, and taste profiles 448. The media data store 424 may comprise one or more databases and file systems. Other embodiments are possible as well.

As discussed herein, the media content items 440 (e.g., including the media content item 432A, the media content item 432B, and the media content item 432N) may be one or more of audio, video, image, or any other type of media content. The media content items 440 may be stored in any format for storing media content. The media content metadata 442 may provide various information associated with the media content items 440. The media content metadata 442 may include a media content format, a title, an artist name, an album name, a length, an episode, a chapter, a playlist, and the like.

The media contexts 444 may be used to identify one or more media content items 440. For example, the media contexts 444 may be configured to group one or more media content items 440 and provide a particular context to the group of media content items 440. Some examples of the media contexts 444 include albums, artists, playlists, podcasts, podcast episodes, audiobooks, authors, audiobook chapters, videos, television episodes, and other media content items. The media contexts 444 may also an order of a group of media content items 440. In other examples, the media contexts 444 may identify a group of the media content items 440 without specifying a particular order.

Each media content item 440 may be identified by a media content item ID, such as the media content ID 214, that may include various pieces of information, such as a media content item title, creator identification (e.g., individual artist name or group name, or multiple artist names or group names), and other media content item data. In some embodiments, the media content item title and the artist are part of the media content metadata 442.

The user accounts 446 may be used to identify users of a media streaming service provided by the media delivery system 104. In some embodiments, a user account 446 allows a user to authenticate to the media delivery system 104 and enable the user to access resources (e.g., media content items, playlists, etc.) provided by the media delivery system 104. In some embodiments, the user can use different devices to log into the user account and access data associated with the user account in the media delivery system 104. User authentication information, such as a username, an email account information, a password, and other credentials, can be used for the user to log into his or her user account.

The taste profiles 448 may contain records indicating media content tastes of users. A taste profile can be associated with a user and used to maintain an in-depth understanding of the media activity and preferences of that user, enabling personalized recommendations, taste profiling, and a wide range of social music applications. Libraries and wrappers can be accessed to create taste profiles from a media library of the user, social website activity, and other specialized databases to determine music preferences. The taste profile may be used to determine media content items to recommend, media comment items to queue, and the like.

The media delivery system 104 may receive requests or other communication from media playback devices or other systems, such as the media playback device 102, to retrieve media content items from the media content server 400.

The format agnostic media playback application system 450 may include a routing system 460, a media content format system 462, and a media content order system 464. The format agnostic media playback application system 450 may send to a device, such as the media playback device 102, a media content response associated with a media content item so the device can determine player features, media content descriptions, user interface formats, and action. In an example, the media content response is a media content response data structure 220.

The routing system 460 may determine the media content response (e.g., media content response data structure 220) to send back to the media playback device 102 based on the user ID, media content ID, and/or playback action the media delivery system 104 receives. For example, the routing system may determine the media content item(s) associated with the media content ID, determine the media content format of the media content item(s), and determine the media content response based on the format(s). The format agnostic media playback application system 450 store media content responses associated with the media content formats in the memory device 454.

The media content format system 462 may determine media content responses, including player features and user interface formats for example, for the different media content formats.

The media content format system 462 may determine media content responses as new media content formats are added to the media service associated with the media delivery system 104.

The player features may be automatically disabled unless the media content format system 462 configures the feature in the media content response. For example, the media content format system 462 may have to enable shuffling, skipping, or seeking for a media content response associated with a playlist or an album. The media content format system 462 may not enable shuffle for the media content response associated with an audiobook to prevent playing the chapters in random order but may enable skipping between the chapters for example.

Many media content formats may have similar playback features and behaviors, such as playlists and albums for examples. The media content format system 462 may use a template stored in the memory device 454 to determine the media content response for the media content formats. For example, for playlists and albums, the template may be a generic container format with shuffle, skipping, and reordering enabled and configured to predetermined defaults. The templates may be regular media content responses and may derive from other templates. The same type of resource references may be used to derive from one or more templates.

The media content order system 464 may determine a timeline for a user device, such as the media playback device 102, to play one or more media content items 440. The media content order system 464 may create timelines with media content items arranged to be played in a sequential order and/or in parallel. The media content order system 464 may determine the arrangement of the media content items relative to the other media content items.

For example, the media content order system 464 may determine for a media content item to start at five seconds from the start of a timeline, a media content item to end five seconds before the timeline, have two media content items start at the same time, have a media content item start three seconds after another media content item starts, have a media content item start eight seconds before another media content item ends, have a media content item start three before another media content item begins, and the like. Thus, the media content order system 464 may arrange the media content items based on the positions of the other media content items.

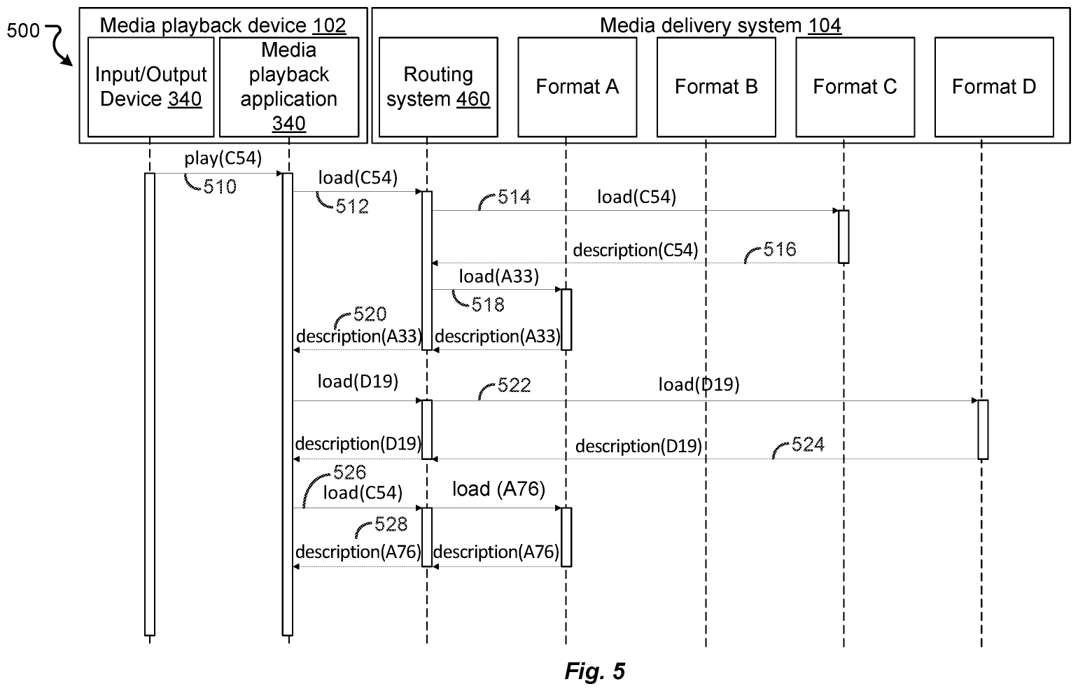

FIG. 5 illustrates a signaling process 500 for providing format agnostic media playback. The signaling process may be between the input/output device 340 and the media playback application 330 of the media playback device 102 and the routing system 460 of the media delivery system 104.

The signaling process 500 may begin with signal 510, and the input/output device 340 may receive an input from a user and send the input to the media playback application 330. The input may include a request to play media content in the format of a playlist. In signal 512, the media playback application 330 may send to the media delivery system 104 a request for the media content. The routing system 460 may receive the request in signal 512.

The routing system 460 may determine the format of the media content is a playlist, and the routing system may request or otherwise determine a media content response associated with the playlist format in signal 514. In signal 516, the routing system 460 may receive the media content response associated with the playlist format.

The routing system 460 may determine the first media content item in the playlist is a song, and the routing system 460 may request or otherwise determine a media content response associated with the song format in signal 518. In signal, 520, the routing system 460 may receive the media content response associated with the song format and provide the media content response associated with the song format and/or the media content response associated with the playlist format to the media playback device 102.

In signal 522, the media playback application 330 may send to the media delivery system 104 a request for new media content, and the routing system 460 may request or otherwise determine a media content response associated with the format of the new media content. The media playback device may receive the media content response associated with the format of the new media content in signal 524.

In signal 526, the media playback device 102 may request to resume playback of the playlist, and the routing system 460 may determine the next media content item in the playlist and request or other otherwise determine a media content response associated with the next media content item. The media playback device 102 may receive the media content response associated with the next media content item in signal 528.

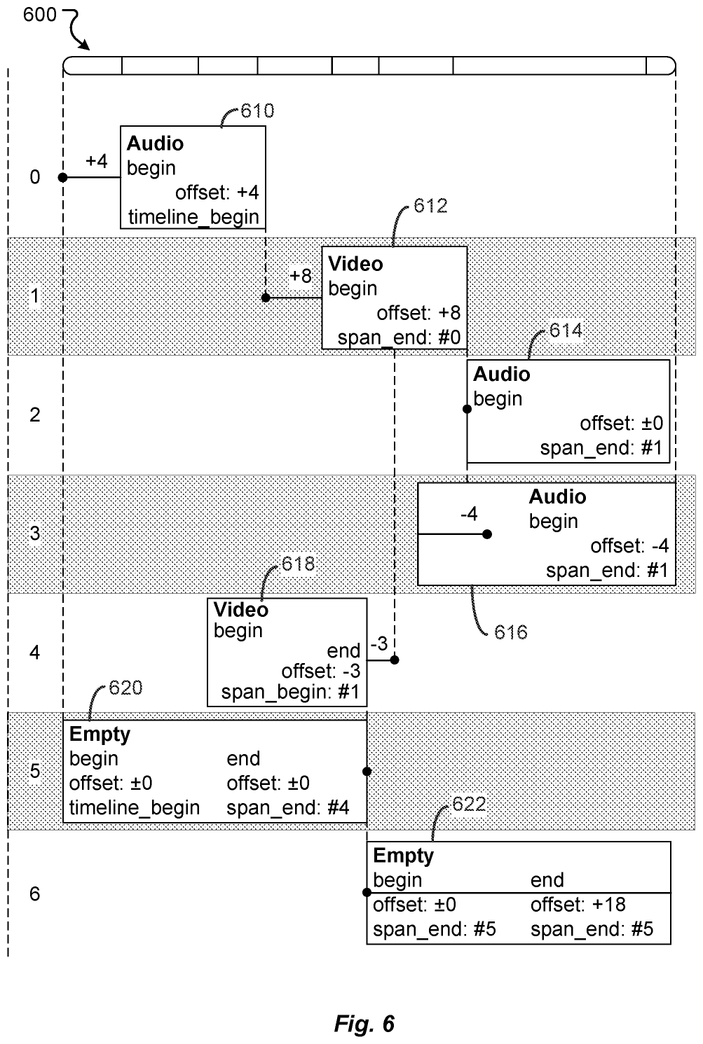

FIG. 6 illustrates a media playback timeline 600. The media playback timeline may include a first audio item 610, a first video item 612, a second audio item 614, a third audio item 616, a second video item 618, a first action item 620, and a second action item 622. The media content order system 464 may determine the arrangement of the media playback timeline 600, including the position of the first audio item 610, the first video item 612, the second audio item 614, the third audio item 616, the second video item 618, the first action item 620, and the second action item 622. The first action item 620 and the second action item 622 may be times for the media playback device to perform an action, such as monitor the playback of the media content items for example.

The media content order system 464 may determine the first audio item 610 to start four seconds from the start of the timeline 600. The media content order system 464 may determine the first video item 612 to start eight seconds from the end of the first audio item 610. The media content order system 464 may determine the second audio item 614 to start at the end of the first video item 612. The media content order system 464 may determine the third audio item 616 to start four seconds before the start of the second audio item 614. The media content order system 464 may determine the second video item 618 to end three seconds before the start of the first video item 612. The media content order system 464 may determine the first action item 61 to start at start of the timeline 600 and end when the second video item 618 ends. The media content order system 464 may determine the first action item 61 to start when the second video item 618 ends and end at the end of the timeline 600.

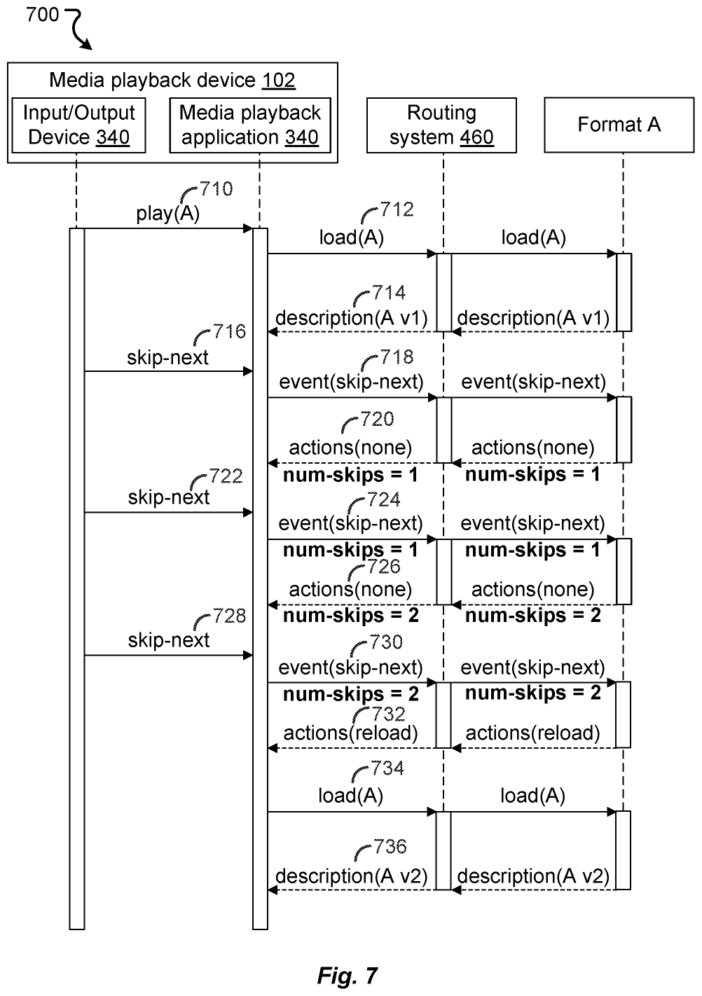

FIG. 7 illustrates a signaling process 700 for providing actions to a media playback device. The signaling process 700 may begin with signal 710, and the input/output device 340 may receive an input from a user and send the input to the media playback application 330. The input may include a request to play media content. In signal 512, the media playback application 330 may send to the media delivery system 104 a request for the media content. The routing system 460 may receive the request in signal 512 and request or otherwise determine a media content response associated with the media content. In signal 714, the routing system 460 may send the media content response associated with the media content to the media playback application 330.

In signal 716, the input/output device 340 may receive an input from the user and send the input to the media playback application 330. The input may include a request to skip the playing media content. In signal 718, the media playback application 330 may send the request to skip to the routing system 460. The routing system 460 may determine that this is the first skip and determine an action of do nothing. The routing system 460 may receive the skip counter or any other data tracking the behavior of the user from the media playback device, such as via signal 718. The routing system 460 may send the action to the media playback application in signal 720.

In signal 722, the input/output device 340 may receive an input from the user and send the input to the media playback application 330. The input may include another request to skip the playing media content. In signal 724, the media playback application 330 may send the request to skip to the routing system 460. The routing system 460 may determine that this is the second skip and determine an action of do nothing. The routing system 460 may receive the skip counter or any other data tracking the behavior of the user from the media playback device, such as via signal 724. The routing system 460 may send the action to the media playback application in signal 726.

In signal 728, the input/output device 340 may receive an input from the user and send the input to the media playback application 330. The input may include another request to skip the playing media content. In signal 730, the media playback application 330 may send the request to skip to the routing system 460. The routing system 460 may determine that this is the third skip and determine an action of reload the queue, because the repeated skips indicate the user does not like the media content in the current queue for example. The routing system 460 may receive the skip counter or any other data tracking the behavior of the user from the media playback device, such as via signal 730. The routing system 460 may send the action to the media playback application in signal 732.

In signal 734, the media playback application 330 may request to reload the queue of media content items in response to the action received in signal 732, and the routing system 460 may determine a media content response associated with the media content of the reloaded queue. In signal 736, the routing system 460 may send the media content response associated with the media content of the reloaded queue to the media playback application 330.

The routing system 460 may send the action in signal 720, signal 726, and signal 732 as a media content response data structure 220. The signal 718, signal 724, and signal 730 may include the routing system 460 determining the media content response associated with the next media content item, when the next media content item is in a different format for example. Therefore, the media playback application may receive the media content responses in signal 720, signal 726, and signal 732.

One or more aspects described herein can be implemented with a computing environment. A computing environment is a set of one or more virtual or physical computers that cause output based on input. Example computers include desktop computers, servers, mobile computing devices, wearable computing devices, virtualized computing devices, other computers, or combinations thereof. Many example computers include one or more processors, memory, and one or more interfaces.

The one or more processors are collections of one or more virtual or physical components that are configured to provide output in response to input. In many examples, the one or more processors are so configured by obtaining and executing instructions (e.g., stored in the memory) and using data (e.g., also stored in the memory). The one or more processors can take any of a variety of forms, such as central processing units, graphics processing units, coprocessors, tensor processing units, artificial intelligence accelerators, microcontrollers, microprocessors, other forms, or combinations thereof. In some examples, the one or more processors are so configured through specifically designed hardware. Examples of such processors include application-specific integrated circuits, field programmable gate arrays, other processors, or combinations thereof.

The memory is a collection of one or more virtual or physical components configured to store instructions or data for later retrieval and use. In many examples, the memory is a non-transitory computer readable medium, though in certain circumstances the memory can be transitory. Examples of transitory memory include data encoded into transient signals. Examples of non-transitory memory include random access memory, cache memory (e.g., which may be incorporated into the one or more processors), read only memory, optical memory, magnetic memory, solid state memory, other memory, or combinations thereof. In some examples, the memory can be configured to be portable, such as enclosed hard drives, thumb drives, CD-ROM disks, DVDs, BLU-RAY disks, other media, or combinations thereof. In some examples, the memory can be incorporated with the one or more processors (e.g., via registers or cache memory).

The one or more interfaces are one or more virtual or physical components by which the computing environment can receive input or provide output. Example interfaces for providing output include one or more visual output components (e.g., displays or lights), auditory output components (e.g., speakers), haptic output components (e.g., vibratory components), other output components, or combinations thereof. Example interfaces for receiving input include one or more visual input components (e.g., still cameras, video cameras, optical sensors), auditory input components (e.g., microphones), haptic input components (e.g., touch or vibration sensitive components), motion input components (e.g., mice, gesture input controllers, or movement sensors), buttons (e.g., keyboards or mouse buttons), position sensors, other input components, or combinations thereof. The one or more interfaces can include components for sending or receiving data from other computing environments or devices, such as one or more wired connections or wireless connections.

One or more of the one or more interfaces can facilitate connection of the computing environment to a network. The network can be a set of one or more other computing devices or environments. Example networks include local area networks, wide area networks, or the Internet.

The environment and its one or more physical computers can include any of a variety of other components to facilitate performance of operations described herein. Example components include one or more power units (e.g., batteries, capacitors, or power harvesters) that provide operational power, one or more busses to provide intra-device communication, one or more cases or housings to encase one or more components, other components, or combinations thereof.

In some instances, the computing device or the environment can be a general-purpose computing device or environment. They may be constructed from one or more consumer or off-the-shelf components. In some instances, via hardware or software configuration, the computing device or the environment can be a special purpose computing device. The one or more computing devices or computing environments can individually or in cooperation to perform operations described herein.

A person of skill in the art, having benefit of this disclosure, may recognize various ways for implementing technology described herein. The person of skill in the art may use any of a variety of programming languages and libraries (e.g., libraries that provide functions for obtaining, processing, and presenting data). Operating systems may provide their own libraries or application programming interfaces useful for implementing aspects described herein. A person of skill in the art, with the benefit of the disclosure herein, can use programming tools to assist in the creation of software or hardware to achieve techniques described herein. Such tools can include intelligent code completion tools, artificial intelligence tools, and/or the like.

A person of skill in the art with the benefit of disclosures herein can use any of a variety of known techniques to implement aspects described herein.

Various embodiments are described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Various modifications and additions can be made to the exemplary examples discussed without departing from the scope of the present invention. For example, while the examples described above refer to particular features, the scope of this invention also includes examples having different combinations of features and examples that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and such references mean at least one of the examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which may be exhibited by some examples and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various examples given in this specification.

Without intent to limit the scope of the disclosure, examples of instruments, apparatus, methods, and their related results according to the examples of the present disclosure are given above. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

What is claimed is:

1. A method comprising:
receiving a request for a media content item from a media playback device;
determining a media content format of the media content item;
determining a media content response based on the media content format; and
sending the media content response to the media playback device.

2. The method of claim 1, wherein the request is a media playback request data structure.

3. The method of claim 1, wherein the media content response is a media content response data structure.

4. The method of claim 1, wherein the media content response includes any of (i) a media content description, (ii) player features, (iii) a user interface format, (iv) actions, or (v) any combination of (i)-(iv).

5. The method of claim 1, further comprising:
receiving a playback action from the media playback device;
determining an action in response to the playback action; and
sending the action to the media playback device.

6. The method of claim 5, wherein:
the playback action is any one of (i) skip to a next media content item, (ii) skip to a previous media content item, (iii) play, (iv) finished playing, (v) failed to play, (vi) shuffle on, (vii) shuffle off, (viii) period passed since starting play, (ix) user subscription change, or (x) any combination of (i)-(ix); and
the action is any one of (xi) do nothing, (xii) reload, (xiii) jump to another media content item, (xiv) pause, (xv) play, (xvi) turn off shuffle, (xvii) turn on shuffle, or (xviii) any combination of (xi)-(xvii).

7. The method of claim 1, further comprising:
determining the media content format is a new media content format; and
creating the media content response for the media content format.

8. The method of claim 1, wherein the request includes a plurality of media content items, and further comprising:
determining a timeline of the plurality of media content items by arranging the plurality of media content items based on the positions of the other media content items.

9. A method comprising:
receiving a request to play a media content item;
sending a request for the media content item to a media delivery system;
receiving a media content response from the media delivery system;
determining any one of (i) a media content description, (ii) player features, (iii) a user interface format, (iv) actions, or (v) any combination of (i)-(iv) based on the media content response;
displaying a user interface based on the media content response; and
playing the media content item.

10. The method of claim 9, wherein the request for the media content item includes any of (vi) a user identifier (ID), (vii) a media content ID, (viii) a playback action, or (ix) any combination of (vi)-(viii).

11. The method of claim 9, wherein the request to play the media content item is a selection of any of (vi) a song, (vii) a playlist, (viii) an album, (ix) a video, (x) a podcast, (xi) an audiobook, or (xii) any combination of (vi)-(xii).

12. The method of claim 9, further comprising:
receiving a playback action;
sending the playback action to the media delivery system;
receiving an action from the media delivery system; and
performing the action.

13. The method of claim 12, wherein:
the playback action is any one of (i) skip to a next media content item, (ii) skip to a previous media content item, (iii) play, (iv) finished playing, (v) failed to play, (vi) shuffle on, (vii) shuffle off, (viii) period passed since starting play, (ix) user subscription change, or (x) any combination of (i)-(ix); and
the action is any of (xi) do nothing, (xii) reload, (xiii) jump to another media content item, (xiv) pause, (xv) play, (xvi) turn off shuffle, (xvii) turn on shuffle, or (xviii) any combination of (xi)-(xvii).

14. The method of claim 9, wherein the media content response includes any of (vi) the media content description, (vii) player features, (viii) the user interface format, (ix) actions, or (x) any combination of (vi)-(ix).

15. The method of claim 9, wherein the media content response includes a timeline of a plurality of media content items, and further comprising playing the plurality of media content items based on the timeline.

16. A system comprising:
a media playback device configured to play media content items; and
a media delivery system configured to:
receive a request for a media content item from the media playback device;
determine a media content format of the media content item;
determine a media content response based on the media content format; and
send the media content response to the media playback device.

17. The system of claim 16, wherein the request is a media playback request data structure.

18. The system of claim 16, wherein the media content response is a media content response data structure.

19. The system of claim 16, wherein the media delivery system is further configured to:
receive a playback action from the media playback device;
determine an action in response to the playback action; and
send the action to the media playback device.

20. The system of claim 16, wherein the media delivery system is further configured to:
determine a timeline of the plurality of media content items by arranging the media content items based on the positions of the other media content items.
